(19) United States
(12) Patent Application Publication
(10) Pub. No.: US 2009/0080453 A1
(43) Pub. Date: Mar. 26, 2009

(54) CONTEXT AWARE IPV6 CONNECTION ACTIVATION IN A UPNP REMOTE ACCESS ENVIRONMENT

(75) Inventor: Vlad Stirbu, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/859,702

(22) Filed: Sep. 21, 2007

(51) Int. Cl. H04J 3/16; G06F 15/173

(52) U.S. Cl. 370/433; 709/202

(57) ABSTRACT

Systems and methods are provided to achieve remote access for Universal Plug and Play (UPnP) devices with Internet Protocol version 6 (IPv6) connectivity. Local discovery messages are monitored and it is determined when UPnP devices join or leave a UPnP network. It is also determined whether the joining devices utilize Internet Protocol version 4 (IPv4) or IPv6 connectivity. If it is determined that an additional IPv6 channel is needed to accommodate a UPnP device with IPv6 capabilities, a transport agent at a remote access server is configured. In addition, a transport agent at a remote access client is also configured. Thus, an IPv6 connection is activated allowing a joined remote UPnP device with IPv6 connectivity to interact to the home network remotely, as if the remote UPnP device was in the home network on an as-needed basis.

### FIELD OF THE INVENTION

The present invention relates generally to Universal Plug and Play (UPnP) networking. More particularly, the present invention relates to triggering Internet Protocol version 6 (IPv6) connectivity between a remote and home network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology defines an architecture for pervasive peer-to-peer network connectivity of intelligent appliances, wireless devices, and personal computer devices of all types. UPnP is designed to bring easy-to-use, flexible, standards-based connectivity to ad-hoc or unmanaged networks whether in the home, in a small business, public spaces, or attached to the Internet. UPnP technology provides a distributed, open networking architecture that leverages Transmission Control Protocol/Internet Protocol (TCP/IP) and Web technologies in order to enable seamless proximity networking, in addition to control and data transfer among networked devices.

The UPnP Device Architecture (UDA) is designed to support zero-configuration, “invisible” networking and automatic discovery for a breadth of device categories from a wide range of vendors. In other words, the UDA enables a device to be capable of dynamically joining a network, obtaining an IP address, conveying the device's capabilities, and learning about the presence and capabilities of other devices. UPnP Remote Access provides an environment that allows a remote UPnP device to connect to a home UPnP network and interact with UPnP devices or entities connected to that home UPnP network, where the UPnP remote device should theoretically have the same experience as if it were in the home UPnP network. Hence, if IPv6 devices are available in the home network and the remote device is IPv6 capable, the remote device is to be able to interact with the home IPv6 devices.

However, the UDA was initially designed to support Internet Protocol version 4 (IPv4)-only connectivity, where subsequent updates (e.g., v1.0.1 and v1.1) have added IPv6 support. However, IPv6 is not yet widely used and the UDA does not mandate the use of IPv6-only devices.

### SUMMARY

Various embodiments comprise a method, computer program product, and an apparatus for establishing an as-needed IPv6 channel between a remote network and a home network. Local discovery messages are monitored at the home network. In these embodiments, it is determined whether at least one of the local discovery messages is transmitted by a UPnP device of the remote network utilizing IPv6 connectivity. Additionally, it is determined whether a need exists to establish an additional as-needed IPv6 channel. Once it is determined that an additional as-needed IPv6 channel is required, the as-needed IPv6 channel is activated.

Other embodiments comprise a method, computer program product, and apparatus for providing IPv6 support for transport agent capability. Context information indicative of at least one UPnP device in a remote network is received. Furthermore, in these embodiments, a remote access server transport agent associated with a home network is configured by indicating IPv6 capability. Additionally, a remote access client transport agent associated with a remote network is also configured, thus providing an as-needed IPv6 channel between the remote network and the home network.

Various embodiments described herein can reduce overhead relative to current remote access utilizing IPv4-only connectivity. Therefore, improved battery performance for a mobile device can be achieved because an IPv6 connection is activated only as needed, which can be particularly beneficial since many devices currently available and likely to be available in the near future will not possess IPv6 connectivity, meaning that implementing IPv6 “always on” connectivity would simply waste battery life. Additionally, various embodiments are scalable in the sense that remote access can be provided for both IPv4 and IPv6 connectivity-based UPnP devices.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates a remote access architecture within which various embodiments are implemented;

FIG. 2 is a representation of discovery information aggregation in accordance with various embodiments;

FIG. 3 is a flow chart illustrating processes performed in accordance with various embodiments;

FIG. 4 is a perspective view of a mobile telephone that can be used in the implementation of various embodiments; and

FIG. 5 is a schematic representation of the telephone circuitry of the mobile telephone of FIG. 4.

### DETAILED DESCRIPTION OF VARIOUS EMBODIMENTS

Various embodiments provide a mechanism for using the Remote Access Discovery Agent (RADA) synchronization function of a remote access architecture to signal when UPnP IPv6 devices become available. Furthermore, various embodiments can trigger the establishment of a IPv6 channel between a remote network and a home network, thus activating IPv6 connectivity for the remote UPnP IPv6 devices in the home network.

The remote access architecture utilizes discovery agents to exchange discovery information from one network to another network, thereby bridging the networks in a RADA synchronization process. Each discovery agent has at least three components, e.g., a listener, a sync, and a relay. The listener is a logical support function of the RADA and can comprise a generic control point that constantly monitors the local network in order to detect which devices are joining or leaving the local network. Alternatively and/or additionally, the listener can monitor local multicast eventing and inform the RADA when multicast events are received.

The sync can refer to a Simple Object Access Protocol (SOAP)-based protocol that helps the discovery agent of a local network push local discovery information to a RADA. More particularly, the sync process comprises closely-connected service and control point functionality, where the control point functionality is utilized to push the local discovery information to a remote network, as described above, and the service functionality is utilized to receive the local discovery information from a remote network. Additionally, the sync process can be performed by two discovery agents that have associations between a local control point and a remote service, as well as between a remote control point and a local service. In other words, the sync process can be thought of as being symmetrical because two discovery agents are synchronizing each other by pushing or exchanging local discovery information to their respective remote ends.

The relay is another logical support function of the RADA and can be a component that recreates original discovery information (e.g., discover information collected by a remote listener and pushed via a sync process) and distributes it within the local network. Additionally, for each device in a remote synchronization tree of the RADA, periodic SSDP announcements can be sent onto the local network indicating that the device is alive. If a device is removed from the remote synchronization tree, the relay can send an SSDP expiration announcement onto the local network.

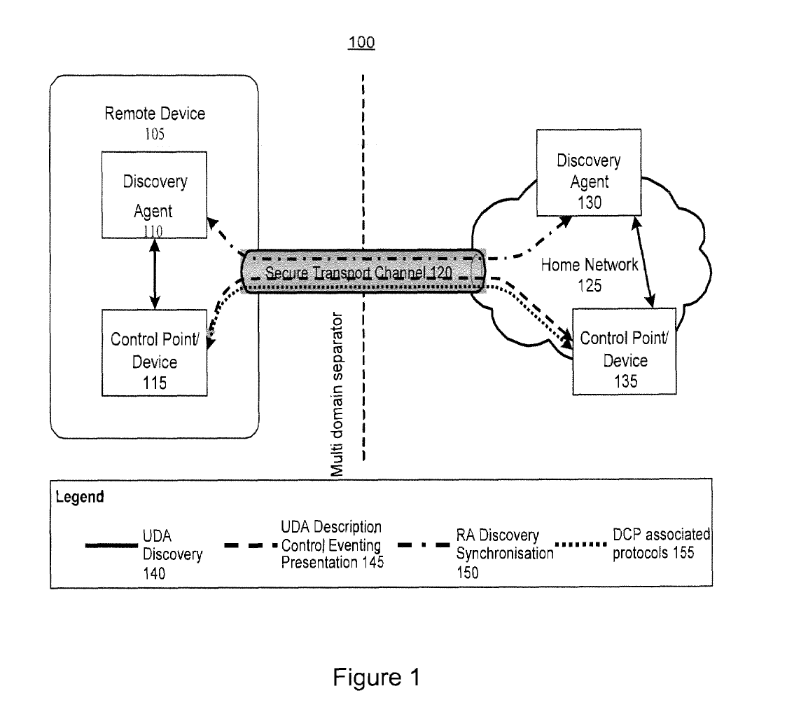

FIG. 1 illustrates a remote access architecture 100, where a remote device 105 is shown as being connected to a home network 125. The remote device 105 comprises a discovery agent 110 and a control point or device 115. As described above, the remote device 105 can comprise a listener, a sync, and a relay (not shown).

FIG. 1 shows that UDA discovery (illustrated as solid line 140) is occurring between the discovery agent 110 and the control point or device 115. The remote access architecture 100 allows the remote device 105 to be visible at the home network 125, even though it is not physically present or connected thereto. This is accomplished via a secure transport channel 120 through which UDA description, control, eventing, and presentation (shown as dashed line 145), remote access (RA) discovery synchronization (shown as dotted and dashed line 150), and device control protocol (DCP)-associated protocols (shown as dotted line 155) can occur. With regard to the RA discovery synchronization 150, local discovery information is pushed between the discovery agent 110 and the control point or device 115 at the remote end, and a discovery agent 130 and control point or device 135 at the home network end.

The UDA mandates IPv4 connectivity for all UPnP devices. However, as described above, the UDA allows for UPnP devices that can support IPv6 connectivity. It should be noted that the IPv6 “roll-out” will increase the number of devices capable of IPv6 connectivity. However, many UPnP devices do not currently have IPv6 connectivity, nor will many UPnP devices have such connectivity in the near future. Thus it is expensive to maintain both IPv4 and IPv6 connectivity to a home network unless UPnP IPv6 devices are actually present in the home network.

Because the listener component of a discovery agent listens for/monitors the local discovery messages, it is able to detect when devices join the UPnP network. Moreover, the listener component can determine whether the devices joining the UPnP network are IPv4 or IPv6-capable. The specific information about the addressing mechanism used can be found in the HOST header of SSDP packets. SSDP packets are the basis of the UPnP discovery protocol, where devices that join a UPnP network advertise services to one or more control points, and control points that join a UPnP network are allowed to search for devices of interest on the UPnP network. Therefore, discovery messages are exchanged between devices and control points, where the discovery messages contain, e.g., essential specifics regarding the device, the control point's available services, etc.

For example, as shown below, a SSDP message indicates that the HOST header contains an address 239.255.255.250. In this instance, it can be determined that the UPnP device that generated this particular SSDP message utilizes IPv4 connectivity.

NOTIFY * HTTP/1.1
HOST: 239.255.255.250:1900
CACHE-CONTROL: max-age = seconds until advertisement expires
LOCATION: URL for UPnP description for root device
NT: notification type
NTS: ssdp:alive
SERVER: OS/version UPnP/1.1 product/version
USN: composite identifier for the advertisement
BOOTID.UPNP.ORG: number increased each time device sends an initial
announce
CONFIGID.UPNP.ORG: number used for caching description information
SEARCHPORT.UPNP.ORG: number identifies port on which device
responds to unicast M-SEARCH

In the following SSDP message, the HOST header contains an address value of [FF02::C]. This value can, for example, indicate that the UPnP device that generated this SSDP message utilizes IPv6 connectivity.

NOTIFY * HTTP/1.1
HOST: [FF02::C]:1900
CACHE-CONTROL: max-age = seconds until advertisement expires
LOCATION: URL for UPnP description of this device
OPT: “http://schemas.upnp.org/upnp/1/0/”; ns=01
01-NLS: same value as BOOTID field value
NT: notification type
NTS: ssdp:alive
SERVER: OS/version UPnP/1.1 product/version
BOOTID.UPNP.ORG: number increased each time device sends an initial
announce or an update message
CONFIGID.UPNP.ORG: number used for caching description information
USN: composite identifier for the advertisement

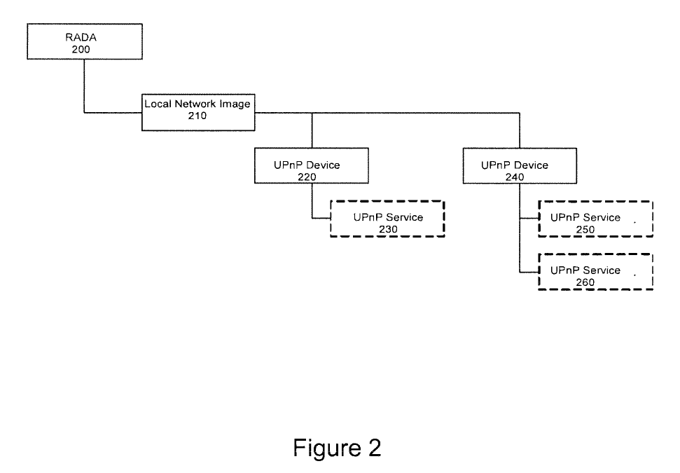

Based on this information regarding the type of UPnP device that generated the SSDP message, the discovery agent can mark those UPnP devices that are dual stack (e.g., a second UPnP Device 240 illustrated in FIG. 2). This information is passed to the RADA 200 via a RADASync::AddRemoteDevice action, which can decide if there is a need to establish an additional IPv6 channel in addition to the default IPv4 secure transport channel. As shown in FIG. 2, the RADA 200 can aggregate information about UPnP devices and services from, e.g., two sources, dependent upon whether the devices are located remotely at a remote device or locally at a home/local network.

As described above, the listener component of the RADA 200 can detect when devices join or leave a network and send notifications of such joining or leaving to the RADA 200. Therefore, the RADA 200 can maintain an up-to-date image of the local UPnP network, e.g., block 210 which is representative of the local network image. As also shown in FIG. 2, the local network image includes a first UPnP device 220, a first UPnP service 230 associated with the first UPnP device 220. The network image in this instance also includes the second UPnP Device 240 noted above, which is associated with a first UPnP service 250 and a second UPnP service 260, both associated with the second UPnP device 240.

A secure transport channel is configured in addition to having the context information about the presence of UPnP IPv6 devices in a remote network in order to allow interaction with the devices. To accomplish this configuration of the secure transport channel, a transport agent is configured via a configuration interface, e.g., RATAConfig, on a Remote Access Server (RAS). It should be noted that the RAS can provide access to the home network from a remote location where a remote device is located, e.g., a residential router, a personal computer, a third party dedicated device, etc. The transport agent IPv6 capability is marked as being present in the transport agent capability. As shown in the syntax below, the IPv6 attribute of the transportAgentCapability is indicated to be “true.”

```
<?xml version=“1.0” encoding=“UTF-8”?>
<RATADT
  xmlns=“urn:schemas-upnp-org:ra:ratadt”
  xmlns:xsi=“http://www.w3.org/2001/XMLSchema-instance”
  xsi:schemaLocation=“urn:schemas-upnp-org:ra:ratadt
  http://www.upnp.org/schemas/ra/ratadt-v0.1-20061116.xsd”>
  <transportAgentCapability transportAgentName=“IPsec” IPv6=“true”>
    <transportAgentOptions>
      <!--Placeholder for defining data specific for each transport
        mechanism. Data structures defined in another namespace-->
    </transportAgentOptions>
    <!--Other transport agent options (if any) go here.-->
  </transportAgentCapability>
  <!--Another transport agent capabilities (if any) go here.-->
</RATADT>
```

The transport agent on the Remote Access Client (RAC) is also configured via a RATAConfig interface at the RAC. It should be noted that the RAC is a peer device that need not be a part of the physical home network to which remote access is desired. When both transport agents at the RAS and the RAC are configured, the discovery agent is able to activate the IPv6 connection by changing the connected flag in the SystemInfo state variable. This is shown in the syntax below, where connected flag is given a value of “true.”

<?xml version=“1.0” encoding=“UTF-8”?>
<RADA xmlns=“urn:schemas-upnp-org:ra:rada”

xmlns:xsi=“http://www.w3.org/2001/XMLSchema-instance”

xsi:schemaLocation=“urn:schemas-upnp-org:ra:rada

http://www.upnp.org/schemas/ra/rada-v0.10-20061201.xsd”>

<systemInfo
updateID=“ ”>
<localNetwork
   <rada
   uuid=“ ”
   exportControlMode=“whiteList”>
      <deviceInfo
         uuid=“ ”
         cache-control=“ ”
         descriptionDocument=“URL to description document”
         server=“ ”>
         <accessControl>
         <access credentialID=“ ”></access>
         <!--Another access (if any) go here.-->
         </accessControl>
      </deviceInfo>
      <!--Another deviceInfo (if any) go here.-->
   </rada>
</localNetwork>
<remoteNetwork>
   <rata
      credentialID=“ ”
      connected=“true”>
   <rada
      uuid=“ ”
      dddLocation=“ ”
      importControlMode=“blackList”
      heartbeat=“ ”>
      <deviceInfo
         uuid=“ ”
         cache-control=“ ”
         descriptionDocument=“ ”
         server=“ ”>
         <accessControl>
         <!--No access elements for remote networks.-->
         </accessControl>
      </deviceInfo>
      <!--Another deviceInfo (if any) go here.-->
   </rada>
</remoteNetwork>

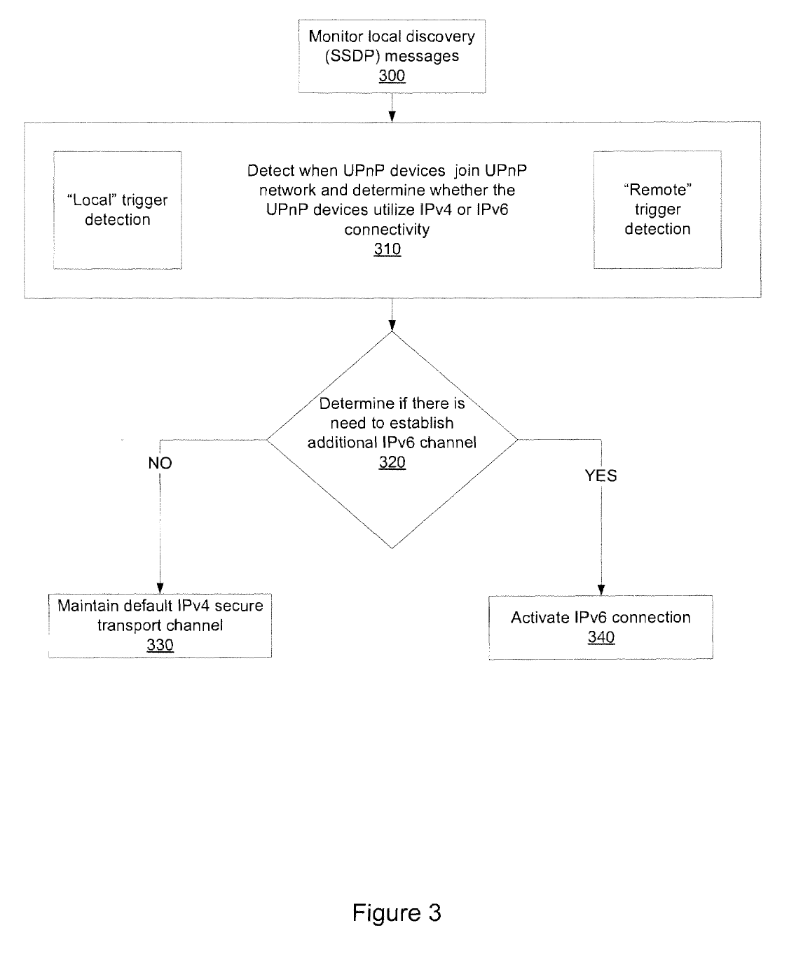

FIG. 3 is a flow chart representative of various processes that are executed in order to achieve IPv6 connectivity in accordance with various embodiments, although it should be noted that more or less processes may be performed in accordance with the various embodiments. Local discovery/SSDP messages are monitored, e.g., by the listener component of the RADA at 300. As described above, the listener component can detect when UPnP devices join or leave a UPnP network, and whether the joining devices utilize IPv4 or IPv6 connectivity at 310. The detection and/or determination at 310 can comprise a process or processes referred to as “local” trigger detection, where the RADA is aware of any UPnP devices having IPv6 connectivity that are present in the remote network and when new UPnP IPv6 devices are joining/have joined the local or home network. Alternatively, a process or processes referred to as “remote” trigger detection can be effectuated to realize the detection and/or determination at 310, e.g., when the RADA is or becomes aware of UPnP devices having IPv6 connectivity in its local network and receives remote discovery information from a remote RADA that new IPv6 connectivity-type UPnP devices are joining/have joined a remote network. At 320, it is determined whether a need exists to establish an additional IPv6 channel to accommodate a UPnP device with IPv6 capabilities that has joined the UPnP network. If not, the default IPv4 secure transport channel is maintained at 330. If, however, it is determined that the additional IPv6 channel is necessary, then the IPv6 connection is activated at 340, as needed, allowing a joined remote UPnP device with IPv6 connectivity to interact to the home network remotely, as if the remote UPnP device was in the home network. It should be noted that the RAS and the RAC can be configured, for example, at the same time that the RAS and the RAC are configured for IPv4 connectivity (not shown). Moreover, such processes described herein can be adapted for initiating connectivity between a first RAS and a second RAS. It should also be noted that because the sync process, described above, is symmetric, the activation of the IPv6 connection can be triggered by activity at either or both of the local and remote network ends. Furthermore, the use of the terms remote, local, and home networks herein can refer to location relative to each other.

As described above, IPv6 connectivity according to various embodiments can be effectuated on an as-needed basis. Therefore, IPv6 channels which have been configured and activated in accordance with various embodiments can also be torn down when UPnP devices with IPv6 connectivity are, e.g., no longer present in the remote network. That is, if the listener component of the RADA, for example, monitors SSDP messages and it is determined that no such messages are being received by UPnP devices having IPv6 connectivity, a trigger is set off indicating that no “motives” exist to maintain the IPv6 channel/connection. Therefore, at least a similar process or processes to that utilized for activating an IPv6 connection can be used, e.g., in reverse or alternatively to tear down the IPv6 connection. In other words, UPnP devices having IPv6 connectivity can be removed from a remote tree using, in part, the sync process, e.g., via a RADASync::RemoveRemoteDevice action, where the remote tree can be likened to the local network image 210 illustrated in FIG. 2, but for a remote network image.

Various embodiments described herein provide a “lightweight solution,” where overhead compared with current remote access utilizing IPv4-only is very small. Furthermore, improved battery performance for a mobile device can be achieved because as described herein, an IPv6 connection is activated only as needed. Additionally, the various embodiments are scalable in the sense that remote access can be provided for both IPv4 and IPv6 connectivity-based UPnP devices.

It should be noted that the system 100 in which the present invention can be utilized, comprising multiple communication devices that can communicate through a network. The system 100 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 100 may include both wired and wireless communication devices.

For exemplification, connectivity in the system 100 shown in FIG. 1 may include, but is not limited to, long range wireless connections, short range wireless connections, and various wired connections including, but not limited to, telephone lines, cable lines, power lines, and the like.

The exemplary communication devices of the system 100 may include, but are not limited to, a mobile device, a combination PDA and mobile telephone, a PDA, an integrated messaging device (IMD), a desktop computer, and a notebook computer. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection to a base station. The base station may be connected to a network server that allows communication between the mobile telephone network and the Internet. The system 100 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

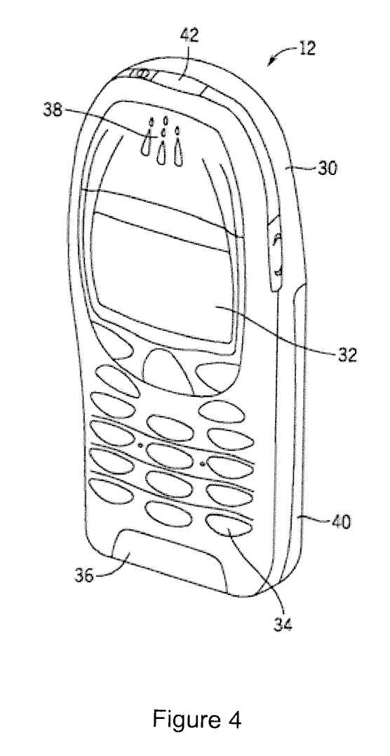

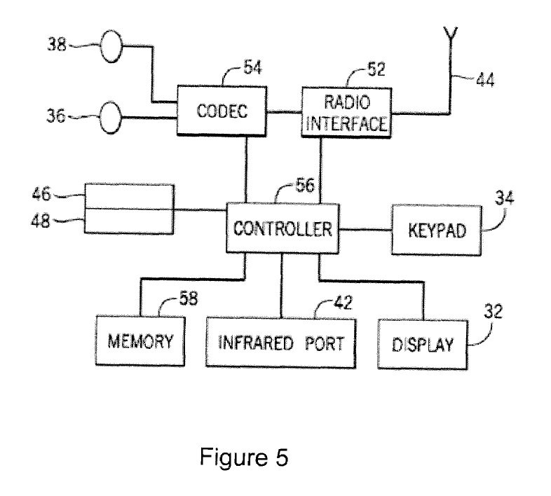

FIGS. 4 and 5 show one representative mobile device 12 within which the present invention may be implemented. It should be understood, however, that the present invention is not intended to be limited to one particular type of electronic device. The mobile device 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of various embodiments could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of various embodiments have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for establishing an as-needed IPv6 channel between a remote network and a local network, comprising:
monitoring one of local discovery messages and remote discovery messages;
upon the monitoring of the local discovery messages, determining whether at least one of the local discovery messages is transmitted by a Universal Plug and Play (UPnP) device of the local network utilizing IPv6 connectivity and upon the monitoring of the remote discovery messages, determining whether at least one of the remote discovery messages is transmitted by a Universal Plug and Play (UPnP) device of the remote network utilizing IPv6 connectivity whether a need 11 exists to establish an additional as-needed IPv6 channel; and
activating the as-needed IPv6 channel.

2. The method of claim 1, wherein the monitoring of the one of the local discovery messages and the remote discovery messages is performed by a listener component of a remote access discovery agent, and wherein the local discovery messages and the remote discovery messages comprise Simple Service Discovery Protocol (SSDP) packets.

3. The method of claim 2 further comprising, notifying the remote access discovery agent when UPnP devices join and leave one of the home network and the remote network.

4. The method of claim 2, wherein the determining of whether the at least one of the local discovery messages and the at least one of the remote discovery messages is transmitted by a UPnP device utilizing IPv6 connectivity comprises determining if an address indicative of an IPv6 host contained in a host header of at least one of the SSDP packets.

5. The method of claim 4, wherein if the host header contains an address indicative of a IPv4 host, only a default IPv4 secure transport channel is maintained.

6. The method of claim 1, wherein the activating of the as-needed IPv6 channel comprises changing a connected flag in a systeminfo state variable to a true value via a remote access discovery agent.

7. The method of claim 1 further comprising, configuring a remote access server transport agent and a remote access client transport agent, wherein a remote access client comprises the UPnP device of one of the remote network and the local network.

8. The method of claim 7, wherein the configuring of the remote access server transport agent comprises marking a transport agent capability as IPv6-capable.

9. The method of claim 1 further comprising, pushing one of the local discovery messages and the remote discovery messages to a remote access discovery agent of the remote network via a sync component of a remote access discovery agent of the local network and vice versa.

10. The method of claim 9 further comprising, recreating and distributing at least one of the local discovery messages and the remote discovery messages at the remote network and the local network.

11. The method of claim 1 further comprising, tearing down the as-needed IPv6 channel when the Universal Plug and Play (UPnP) device no longer exists in one of the remote network and the home network.

12. A computer program product, embodied on a computer-readable medium, comprising computer code configured to implement the processes of claim 1.

13. An apparatus, comprising
a processor; and
a memory unit communicatively connected to the processor and including:
computer code configured to monitor one of local discovery messages of a local network and remote discovery messages of a remote network;
computer code configured to at least one of determine whether at least one of the local discovery messages is transmitted by a Universal Plug and Play (UPnP) device of the local network utilizing IPv6 connectivity and determine whether at least one of the remote discovery messages is transmitted by a Universal Plug and Play (UPnP) device of the remote network utilizing IPv6 connectivity, and whether a need exists to establish an additional as-needed IPv6 channel; and
computer code configured to activate the as-needed IPv6 channel between the remote network and the local network.

14. The apparatus of claim 13, wherein the monitoring of one of the local discovery messages and the remote discovery messages is performed by a listener component of a remote access discovery agent, and wherein the local discovery messages and the remote discovery messages comprise Simple Service Discovery Protocol (SSDP) packets.

15. The apparatus of claim 14 wherein the memory unit further comprises computer code configured to notify the remote access discovery agent when UPnP devices join and leave one of the local network and the remote network.

16. The apparatus of claim 14 wherein the memory unit further comprises computer code configured to determine if an address indicative of an IPv6 host contained in a host header of at least one of the SSDP packets.

17. The apparatus of claim 16, wherein if the host header contains an address indicative of a IPv4 host, only a default IPv4 secure transport channel is maintained.

18. The apparatus of claim 13, wherein the memory unit further comprises computer code configured to change a connected flag in a systeminfo state variable to a true value via a remote access discovery agent.

19. The apparatus of claim 13, wherein the memory unit further comprises computer code configured to configure a remote access server transport agent and a remote access client transport agent, wherein a remote access client comprises the UPnP device of one of the remote network and the local network.

20. The apparatus of claim 19, wherein the memory unit further comprises computer code configured to mark a transport agent capability as IPv6-capable.

21. The apparatus of claim 13, wherein the memory unit further comprises computer code configured to push one of the local discovery messages and the remote discovery messages to a remote access discovery agent of the remote network via a sync component of a remote access discovery agent of the local network and vice versa.

22. The apparatus of claim 21, wherein the memory unit further comprises computer code configured to recreate and distribute at least one of the local discovery messages and the remote discovery messages at the remote network and the local network.

23. The apparatus of claim 13, wherein the memory unit further comprises computer code configured to tear down the as-needed IPv6 channel when the Universal Plug and Play (UPnP) device no longer exists in one of the remote network and the home network.

24. An apparatus, comprising
means for monitoring one of local discovery messages of a local network and remote discovery messages of a remote network;
means for determining at least one of whether at least one of the local discovery messages is transmitted by a Universal Plug and Play (UPnP) device of a remote network utilizing IPv6 connectivity and whether at least one of the remote discovery messages is transmitted by a Universal Plug and Play (UPnP) device of the remote network utilizing IPv6 connectivity, and whether a need exists to establish an additional as-needed IPv6 channel; and
means for activating the as-needed IPv6 channel between the remote network and the home network.

25. The apparatus of claim 24, wherein the means for determining at least one of whether the at least one of the local discovery messages and the remote discovery messages is transmitted by a UPnP device utilizing IPv6 connectivity further determines if an address indicative of an IPv6 host contained in a host header of at least one of the SSDP packets.

26. A method of providing IPv6 support for transport agent capability, comprising:
receiving context information indicative of at least one Universal Plug and Play (UPnP) device in one of a remote network and a local network;
configuring a remote access server transport agent associated with one of the remote network and the local network by indicating IPv6 capability; and
configuring a remote access client transport agent associated with one of the remote network and the local network to provide an as-needed IPv6 channel between the remote network and the local network.

27. The method of claim 26, wherein the received context information comprises one of local discovery messages and remote discovery messages monitored by a listener component of a remote access discovery agent of one of the local network and the remote network, and wherein the local discovery messages and the remote discovery messages comprise Simple Service Discovery Protocol (SSDP) packets.

28. The method of claim 27 further comprising, notifying the remote access discovery agent of one of the local network and the remote network when UPnP devices join and leave one of the local network and the remote network.

29. The method of claim 27 further comprising, determining whether one of at least one of the local discovery messages and the remote discovery messages is transmitted by a UPnP device utilizing IPv6 connectivity.

30. The method of claim 29 further comprising, determining if an address indicative of an IPv6 host is contained in a host header of at least one of the SSDP packets.

31. The method of claim 27 further comprising, pushing one of the local discovery messages and the remote discovery messages to a remote access discovery agent of the remote network via a sync component of a remote access discovery agent of the local network and vice versa.

32. The method of claim 30 further comprising, recreating and distributing at least one of the local discovery messages and the remote discovery messages at the remote network and the local network.

33. The method of claim 26, wherein the providing of the as-needed IPv6 channel comprises changing a connected flag in a systeminfo state variable to a true value via a remote access discovery agent.

34. The method of claim 26, wherein the configuring of the remote access server transport agent comprises marking a transport agent capability as IPv6-capable.

35. The method of claim 26 further comprising, tearing down the as-needed IPv6 channel when the Universal Plug and Play (UPnP) device no longer exists in one of the remote network and the home network.

36. A computer program product, embodied on a computer-readable medium, comprising computer code configured to implement the processes of claim 26.

37. An apparatus, comprising:
a processor; and
a memory unit communicatively connected to the processor and including:
computer code configured to receive context information indicative of at least one Universal Plug and Play (UPnP) device in one of a remote network and a local network;
computer code configured to configure a remote access server transport agent associated with one of the remote network and the local network by indicating IPv6 capability; and
computer code configured to configure a remote access client transport agent associated with one of the remote network and the local network to provide IPv6 support for transport agent capability, effectuating an as-needed IPv6 channel between the remote network and the local network.

38. The apparatus of claim 37, wherein the received context information comprises one of local discovery messages and remote discovery messages monitored by a listener component of a remote access discovery agent of one of the local network and the remote network, and wherein the local discovery messages and the remote discovery messages comprise Simple Service Discovery Protocol (SSDP) packets.

39. The apparatus of claim 38, wherein the memory unit further comprises computer code configured to notify the remote access discovery agent of one of the local network and the remote network when UPnP devices join and leave one of the local network and the remote network.

40. The apparatus of claim 38, wherein the memory unit further comprises computer code configured to determine whether one of at least one of the local discovery messages and at least one of the remote discovery messages is transmitted by a UPnP device utilizing IPv6 connectivity.

41. The apparatus of claim 40, wherein the memory unit further comprises computer code configured to determine if an address indicative of an IPv6 host is contained in a host header of at least one of the SSDP packets.

42. The apparatus of claim 38, wherein the memory unit further comprises computer code configured to push one of the local discovery messages and the remote discovery messages to a remote access discovery agent of the remote network via a sync component of a remote access discovery agent of the local network and vice versa.

43. The apparatus of claim 42, wherein the memory unit further comprises computer code configured to recreate and distribute at least one of the local discovery messages and the remote discovery messages at the remote network and the home network.

44. The apparatus of claim 37, wherein the memory unit further comprises computer code configured to change a connected flag in a systeminfo state variable to a true value via a remote access discovery agent.

45. The apparatus of claim 37, wherein the memory unit further comprises computer code configured to mark a transport agent capability as IPv6-capable.

46. The apparatus of claim 37, wherein the memory unit further comprises computer code configured to tear down the as-needed IPv6 channel when the Universal Plug and Play (UPnP) device no longer exists in one of the remote network and the home network.

47. An apparatus, comprising:
means for receiving context information indicative of at least one Universal Plug and Play (UPnP) device in one of a remote network and a local network;
means for configuring a remote access server transport agent associated with one of the remote network and the local network by indicating IPv6 capability; and
means for configuring a remote access client transport agent associated with one of the remote network and the local network to provide IPv6 support for transport agent capability, effectuating an as-needed IPv6 channel between the remote network and the local network.

48. The method of claim 47, wherein the received context information comprises one of local discovery messages and remote discovery messages monitored by a listener component of a remote access discovery agent of one of the remote network and the local network, and wherein the local discovery messages and the remote discovery messages comprise Simple Service Discovery Protocol (SSDP) packets.
